(19) United States
(12) Patent Application Publication
(10) Pub. No.: US 2018/0178248 A1
(43) Pub. Date: Jun. 28, 2018

(54) FUNCTIONALIZED SURFACES FOR MULTIPHASE WETTABILITY

(71) Applicant: ExxonMobil Research and Engineering Company, Annandale, NJ (US)

(72) Inventors: Srinivasan RAJAGOPALAN, Easton, PA (US); Ning MA, Whitehouse Station, NJ (US); Qiuzi LI, Clinton, NJ (US); Robert J. COLBY, Annandale, NJ (US); George E. JEZEK, Pittstown, NJ (US); Jonathan PITA, Parlin, NJ (US)

(21) Appl. No.: 15/838,663

(22) Filed: Dec. 12, 2017

Related U.S. Application Data
(60) Provisional application No. 62/438,498, filed on Dec. 23, 2016.
(60) Provisional application No. 62/438,496, filed on Dec. 23, 2016.

(51) Int. Cl. B05D 5/08; C23F 15/00; B05D 3/00; B05D 7/22

(52) U.S. Cl. CPC B05D 5/083; B05D 7/222; B05D 3/007; C23F 15/00

(57) ABSTRACT

Described herein are methods of manipulating/tailoring wettability of liquids on physically/chemically modified surfaces under multiphase conditions (i.e. >1 liquid contacting surface). In particular, methods of modifying or tuning the wettability of a surface in multiphase conditions could decelerate corrosion, modify drag in a pipe, and/or enable separation of a two-phase liquid system.

### CROSS-REFERENCE TO RELATED APPLICATIONS

This application claims the benefit of U.S. Provisional Application No. 62/438,498, filed on Dec. 23, 2016, the entire contents of which are incorporated herein by reference.

This application also claims the benefit of related U.S. Provisional Application No. 62/438,496, filed on Dec. 23, 2016, the entire contents of which are also incorporated herein by reference.

### FIELD

The description provides method of manipulating/tailoring wettability of liquids on physically/chemically modified surfaces under multiphase conditions (i.e. at least two liquids contacting surface).

### BACKGROUND

Interactions at solid-liquid interfaces are governed by the relative surface energies and surface tensions of the solid and liquid phase(s). The ability to modify these surface energies through modification of the solid surface offers the ability to control and manipulate the interactions and resultant properties, e.g., wettability of the liquid(s). In addition, other related processes such as adsorption (of liquid) or other solids (that may exist in the liquid phase) can be controlled.

The basic theory behind solid-liquid surface interactions can be traced back to Young's equation, which gives a simple energy balance to explain how liquids may wet a solid surface. The Young's equation essentially states that wettability is governed entirely by surface energies, or in other words, through surface chemistry. Later on, Wenzel and Cassie-Baxter to incorporate the effects of surface roughness and texturing provided modifications to Young's equation.

Surface functionalization can be achieved through two primary means: physical functionalization and chemical functionalization. For physical functionalization, the surface is given a physical attribute such as a roughness or pattern or texture, that can either enhance its existing attribute (e.g., through Wenzel's model, enhancing surface roughness can make an intrinsically hydrophobic surface more hydrophobic), or enable a change in wettability regime through design of a composite interface (e.g., through the Cassie-Baxter model, design of a suitable pattern/texture on a surface can stabilize a metastable hydrophobic wetting state on an intrinsically hydrophilic surface). It should be noted that the design of suitable texture/patterns is still dependent upon the surface tensions of the contacting liquid(s).

For chemical functionalization, the surface is imparted a different chemistry by means of intrinsic functionalization (e.g., doping, surface implantation) or application of an extrinsic coating onto the solid surface (e.g., low-energy coatings such as Teflon). Pure chemical functionalization can alter wettability state of a surface only by providing a different Wenzel wetting condition—generally metastable Cassie-Baxter conditions cannot be created here.

In most cases, a synergistic application of physical and chemical functionalization may be necessary to achieve the desired attributes. For example, some low surface-tension liquids (e.g., with surface tension values ˜10-20 mN/m) may yield low contact angles (i.e. high wettability) on surfaces that are either physically or chemically modified, but a combination of both approaches may result in metastable, low-wetting (Cassie-Baxter) states of such liquids on surfaces of interest.

Primary focus in this area has centered on the development of surfaces that impart properties such as superhydrophobicity or oleophobicity. This almost always applies to single-phase liquid systems, where there are three primary components: a surface, a liquid of interest (e.g., oil or water) and air (to create or support a metastable C-B state). However, the situation regarding two-phase or multiphase systems has received relatively little attention. In most real-life situations, multiphase interactions drive the resultant performance characteristic; thus, surface design for multiphase wettability is an important consideration for many applications.

### SUMMARY

The present disclosure is directed to methods of manipulating/tailoring wettability of liquids on physically and/or chemically modified surfaces under multiphase conditions (e.g., more than one liquid contacting surface). In the current context, the components of the multiphase system are in contact with the surface of interest, which is designed to modify or manipulate wettability state(s) of one component, e.g., liquid, preferentially over the other. Furthermore, the described methods of modifying or tuning the wettability of a surface could enable certain applications, such as decelerating corrosion, modifying drag in a pipe, and/or enabling separation of a two-phase liquid system.

Thus, in one aspect, the description provides a method of modifying or tuning the wettability of a surface in multiphase conditions including: providing a surface and a multiphase fluid, wherein there are at least two distinct phases in a liquid solution or emulsion; modifying the surface chemically, and/or functionalizing the surface physically, wherein the method effectuates the modification or tuning of the multiphase wettability of the surface.

In one embodiment, the multiphase fluid is an immiscible or partially miscible mixture of at least two different liquids with distinct surface tensions. In another embodiment, the method of modifying or tuning the wettability of a surface in multiphase conditions provides a surface with at least one liquid contact angle in air to be 90 degrees or higher, and another liquid contact angle in air to be 20 degrees or lower. In yet another embodiment, the method of modifying or tuning the wettability of a surface in multiphase conditions provides a surface with one liquid contact angle in another liquid to be 20 degrees or lower. In yet another embodiment, the method of modifying or tuning the wettability of a surface in multiphase conditions provides a surface with one liquid contact angle in another liquid to be 100 degrees or higher. In each of the latter two embodiments, the liquid of interest (i.e. where the contact angle or wettability is specified) can have higher or lower surface tension than the other liquid phase.

In certain embodiments, the chemical modification in the method of modifying or tuning the wettability of a surface in multiphase conditions comprises at least one of application of a coating, ion implantation, surface alloying or other associated techniques or a combination thereof. In one embodiment, the chemical modification is application of a coating. In certain embodiments, the coating is at least one of a fluorinated polymer coating or a silicone-based polymer coating.

In certain embodiments, the physical functionalization comprises at least one of micro-patterning, etching, or casting to create a rough or patterned texture. In one embodiment, the physical functionalization is micro-patterning.

In certain embodiments, the description provides a method of modifying or tuning the wettability of a surface in multiphase conditions including: providing a surface and a multiphase fluid, (e.g., a solution or an emulsion); modifying the surface chemically, and/or functionalizing the surface physically, wherein the surface is hydrophobic and oleophilic in air and the method effectuates the modification or tuning of the multiphase wettability of the surface.

In any of the aspects or embodiments described herein, the surface comprises or is steel.

In certain aspects, the description provides a micro-patterned fluorinated carbon steel surface that is produced according to the methods described herein.

In yet another aspect, the description provides a micro-patterned silicone-treated carbon steel surface that is produced according to the methods described above.

In one aspect, the description provides a method of decelerating or reducing corrosion of a metallic material surface including the steps of: modifying the surface of the metallic material surface chemically, and/or functionalizing the metallic material surface physically; and exposing the metallic material surface to a multiphase fluid, e.g., a solution or emulsion, wherein the method effectuates a reduction in corrosion of the surface as compared to an unmodified metallic material surface.

In certain embodiments, the multiphase solution in the method of decelerating corrosion of a metallic material surface is an immiscible or partially miscible mixture of at least two different liquids with distinct or disparate surface tensions. In another embodiment, the method of decelerating corrosion of a metallic material surface provides a surface with at least one liquid contact angle in air to be 90 degrees or higher in a multiphase solution, and another liquid contact angle in air to be 20 degrees or lower in the multiphase solution. In yet another embodiment, the method of decelerating corrosion of a metallic material surface provides a surface with one liquid contact angle in another liquid to be 20 degrees or lower, so as to provide preferential wetting of the surface by that particular liquid (e.g. preferential wetting of a surface by oil over water).

In certain embodiments, the chemical modification in the method of decelerating corrosion of a metallic material surface comprises at least one of application of a coating, ion implantation, surface alloying or other associated techniques or a combination thereof. In one embodiment, the chemical modification is application of a coating, and the coating is a fluorinated polymer coating or a silicone-based polymer coating.

In certain embodiments, the physical functionalization in the method of decelerating corrosion of a metallic materials surface comprises at least one of micro-patterning, etching, or casting to create a rough or patterned texture. In one embodiment, the physical functionalization is micro-patterning.

In certain embodiments, the description provides a method of decelerating corrosion of a metallic material surface including: modifying the surface of the metallic material surface chemically, and/or functionalizing the metallic material surface physically; and exposing the metallic materials surface to a multiphase fluid, e.g., a solution or emulsion (with two or more distinct phases); wherein the metallic material surface is rendered hydrophobic and oleophilic in air through the surface modification techniques noted above, and the method effectuates a reduction in corrosion of the metallic material surface as compared to an unmodified metallic material surface.

In another aspect, the description provides a metallic material surface that is produced according to the methods as described herein.

In another aspect, the description provides a method of drag modification in a pipe including: applying a coating on the internal surface of the pipe and/or functionalizing the internal surface of the pipe physically through micro-patterning; and exposing internal surface of the pipe in multiphase conditions, wherein the method effectuates a reduction of drag by preferential wetting of a less viscous liquid on the surface.

In one embodiment, the multiphase condition comprises an immiscible or partially miscible mixture of at least two different liquids with distinct or disparate surface tensions.

In certain embodiments, the coating in the method of drag modification in a pipe comprises a fluorinated polymer coating or a silicone-based polymer coating.

In another aspect, the description provides a pipe that is produced according to the methods of drag modification in a pipe as described herein.

In another aspect, the description provides a method of enabling separation of a two-phase liquid system comprising: providing a material having a surface; selecting a surface chemistry for enabling separation of a two-phase liquid system; modifying the surface chemically through applying a coating and/or functionalizing the surface physically through micro-patterning; and applying the two-phase liquid on the surface, wherein one of the liquids preferentially wets the surface.

In one embodiment, the two-phase liquid system comprises an immiscible or partially miscible mixture of two different liquids with distinct or disparate surface tensions.

Where applicable or not specifically disclaimed, any one of the embodiments described herein are contemplated to be able to combine with any other one or more embodiments, even though the embodiments are described under different aspects of the invention.

The preceding general areas of utility are given by way of example only and are not intended to be limiting on the scope of the present disclosure and appended claims. Additional objects and advantages associated with the compositions, methods, and processes of the present invention will be appreciated by one of ordinary skill in the art in light of the instant claims, description, and examples. For example, the various aspects and embodiments of the disclosure may be utilized in numerous combinations, all of which are expressly contemplated by the present description. These additional advantages objects and embodiments are expressly included within the scope of the present disclosure. The publications and other materials used herein to illuminate the background of the disclosure, and in particular cases, to provide additional details respecting the practice, are incorporated by reference.

### BRIEF DESCRIPTION OF THE FIGURES

FIG. 1 illustrates a schematic representation of Young's contact angle, Wenzel and Cassie-Baxter Wetting state.

FIG. 2 illustrates a schematic representation of single phase and multiphase wettability.

FIG. 3 illustrates the effect of surface functionalization on multiphase wettability for a surface-oil-water system

### DETAILED DESCRIPTION

Presently described are methods of modifying or tuning the wettability of a surface that surprisingly and unexpectedly performs well in multiphase conditions. In particular, the described methods of modifying or tuning the wettability of a surface could enable certain applications, such as decelerating corrosion, modifying drag in a pipe, and/or enabling separation of a two-phase liquid system.

The following is a detailed description of the disclosure provided to aid those skilled in the art in practicing the present disclosure. Those of ordinary skill in the art may make modifications and variations in the embodiments described herein without departing from the spirit or scope of the present disclosure. Unless otherwise defined, all technical and scientific terms used herein have the same meaning as commonly understood by one of ordinary skill in the art to which this disclosure belongs. The terminology used in the description of the disclosure herein is for describing particular embodiments only and is not intended to be limiting of the disclosure. All publications, patent applications, patents, figures and other references mentioned herein are expressly incorporated by reference in their entirety.

It should also be understood that, unless clearly indicated to the contrary, in any methods claimed herein that include more than one step or act, the order of the steps or acts of the method is not necessarily limited to the order in which the steps or acts of the method are recited.

The following terms are used to describe the present disclosure. In instances where a term is not specifically defined herein, that term is given an art-recognized meaning by those of ordinary skill applying that term in context to its use in describing the present disclosure.

The articles “a” and “an” as used herein and in the appended claims are used herein to refer to one or to more than one (i.e., to at least one) of the grammatical object of the article unless the context clearly indicates otherwise. By way of example, “an element” means one element or more than one element.

The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of’ or “exactly one of,” or, when used in the claims, “consisting of,” will refer to the inclusion of exactly one element of a number or list of elements. In general, the term “or” as used herein shall only be interpreted as indicating exclusive alternatives (i.e., “one or the other but not both”) when preceded by terms of exclusivity, such as “either,” “one of,” “only one of,” or “exactly one of.”

The term “about” or “approximately” means an acceptable error for a particular value as determined by one of ordinary skill in the art, which depends in part on how the value is measured or determined. All numerical values within the detailed description and the claims herein are modified by “about” the indicated value.

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of’ and “consisting essentially of’ shall be closed or semi-closed transitional phrases, respectively, as set forth in the 10 United States Patent Office Manual of Patent Examining Procedures, Section 2111.03.

As used herein, unless the context indicates otherwise, the term “surface roughness” or “roughness” (R) is used in reference to a surface feature of a manufactured item, e.g., a metallic or alloy component, such as, e.g., for use in a mechanical system. R is quantified by the deviations in the direction of the normal vector of a real surface from its ideal form. If these deviations are large, the surface is rough; if they are small, the surface is smooth.

As used herein, unless the context indicates otherwise, the term “multiphase” is a condition created due to the presence of one or more immiscible or partially miscible liquids, that results in at least two distinct phases of a fluid, e.g., liquid(s). In the current context, the phases are in contact with the surface of interest, which is designed to modify or manipulate wettability state(s) of one component of the multiphase fluid, e.g., liquid, such as a solution or emulsion, preferentially over the other.

As used herein, unless the context indicates otherwise, the term “contact angle” is the angle between the solid and liquid surfaces. Wetting is characterized by the contact angle. If the liquid or oil wets the surface (referred to as a hydrophilic/oleophilic surface), the value of the contact angle is 0°<θ<90°, whereas, if the liquid or oil does not wet the surface (referred to as a hydrophobic/oleophobic surface), the value of the contact angle is 90°<θ<180°. The term hydrophobic/philic, which was originally applied only to water, is often used to describe the contact of a solid surface with any liquid. The term “oleophobic/philic” is used with regard to wetting by oil and organic liquids.

As used herein, unless the context indicates otherwise, the term “composite interface” or “composite surface” is an interface (or surface) that can sustain a metastable Cassie-Baxter wettability state of a liquid. The composite interface generally implies an interface where the surface is in contact with the liquid and air (pockets) that are created due to texturing/patterning and an optional chemical modification of the surface

As used herein, unless the context indicates otherwise, the term “physical modification” is a method of texturing and/or patterning to create physically distinguishable and distinct features with topography on desired length scale(s).

As used herein, unless the context indicates otherwise, the term “chemical modification” is a method of altering the surface energy of a composite interface or surface by changing the surface chemistry. This can be achieved through application of an extrinsically applied coating, or intrinsic modification of the solid surface through techniques such as ion implantation or surface alloying.

As used herein, unless the context indicates otherwise, the term “hydrophobicity” is the property of a composite interface or surface whereby a static apparent water contact angle of greater than 90 degrees is observed. In general, this can be extended to other liquids, where the term “-phobicity” implies an apparent contact angle of greater than 90 degrees for that particular liquid in contact with the surface of interest. For example, “oleophobicity” is the property of a surface whereby a static apparent contact angle of greater than 90 degrees is observed for a particular organic liquid (e.g., heptane, toluene).

As used herein, unless the context indicates otherwise, the term “hydrophilicity” is the property of a surface whereby a static apparent water contact angle of less than 90 degrees is observed. In general, this can be extended to other liquids, where the term “-philicity” implies an apparent contact angle of less than 90 degrees for that particular liquid in contact with the surface of interest. For example, “oleophilicity” is the property of a surface whereby a static apparent contact angle of less than 90 degrees is observed for a particular organic liquid (e.g., heptane, toluene).

As used herein, unless the context indicates otherwise, the term “omniphobicity” is the property of a surface whereby a static apparent contact angle of greater than 90 degrees is observed for many liquids (aqueous and organic).

As used herein, unless the context indicates otherwise, the term “superhydrophobicity” is the property of a surface whereby a static apparent water contact angle of greater than 150 degrees is observed.

As used herein, unless the context indicates otherwise, the term “micro-patterning” is the creation of texture or pattern on the surface of a solid substrate with features and inter-feature spacing typically on the order of several micrometers to several hundred micrometers.

As used herein, unless the context indicates otherwise, the term “nano-patterning: Creation of texture or pattern on the surface of a solid substrate with features and inter-feature spacing typically on the order of several nanometers to several hundred nanometers.

### Surface Wettability

Interactions at solid-liquid interfaces are governed by the relative surface energies and surface tensions of the solid and liquid phase(s). The ability to modify these surface energies through modification of the solid surface offers the ability to control and manipulate the interactions and resultant properties, e.g., wettability of the liquid(s). In addition, other related processes such as adsorption (of liquid) or other solids (that may exist in the liquid phase) can be controlled.

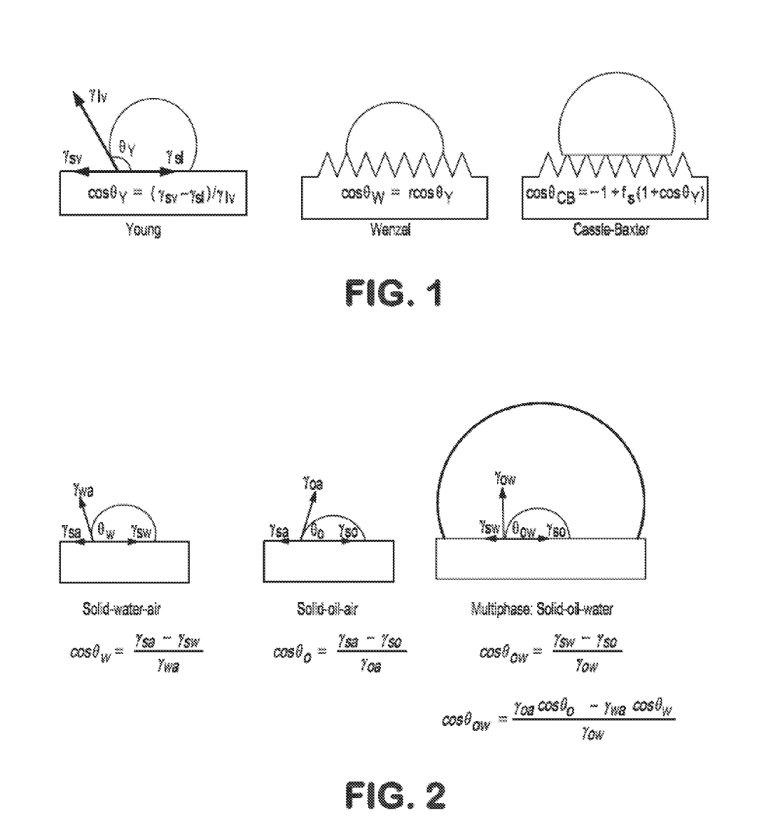

The basic theory behind solid-liquid surface interactions can be traced back to Young's equation, which gives a simple energy balance to explain how liquids may wet a solid surface. The Young's equation essentially states that wettability is governed entirely by surface energies, or in other words, through surface chemistry. Later on, modifications to Young's equation were provided (by Wenzel and Cassie-Baxter) to incorporate the effects of surface roughness and texturing, as schematically shown in FIG. 1 (note: the equation for Cassie-Baxter case depicts the scenario of air pockets and pillar geometry for surface texture features).

Surface functionalization can be achieved through two primary means: physical functionalization and chemical functionalization. For physical functionalization, the surface is given a physical attribute such as a roughness or pattern or texture, that can either enhance its existing attribute (e.g., through Wenzel's model, enhancing surface roughness can make an intrinsically hydrophobic surface more hydrophobic), or enable a change in wettability regime through design of a composite interface (e.g., through the Cassie-Baxter model, design of a suitable pattern/texture on a surface can stabilize a metastable hydrophobic wetting state on an intrinsically hydrophilic surface). It should be noted that the design of suitable texture/patterns is still dependent upon the surface tensions of the contacting liquid(s). For chemical functionalization, the surface is imparted a different chemistry by means of intrinsic functionalization (e.g., doping, surface implantation) or application of an extrinsic coating onto the solid surface (e.g., low-energy coatings such as Teflon). Pure chemical functionalization can alter wettability state of a surface only by providing a different Wenzel wetting condition—generally metastable Cassie-Baxter conditions cannot be created here.

In most cases, a synergistic application of physical and chemical functionalization may be necessary to achieve the desired attributes. For example, some low surface-tension liquids (e.g., with surface tension values ˜10-20 mN/m) may yield low contact angles (i.e. high wettability) on surfaces that are either physically or chemically modified, but a combination of both approaches may result in metastable, low-wetting (Cassie-Baxter) states of such liquids on surfaces of interest.

Primary focus in this area has centered on the development of surfaces that impart properties such as superhydrophobicity or oleophobicity. This almost always applies to single-phase liquid systems, where there are three primary components: a surface, a liquid of interest (e.g., oil or water) and air (to create or support a metastable C-B state). However, the situation regarding two-phase or multiphase systems has received relatively little attention. In most real-life situations, multiphase interactions drive the resultant performance characteristic; thus, surface design for multiphase wettability is an important case for technology application.

The present disclosure provides solutions to a multiphase wettability situation where more than one liquid (immiscible or with very limited miscibility) can be in contact with a surface. In such cases, the relative interplay of surface energies between the solid and the liquid(s) under consideration can play an important role in determining wettability, in addition to the surface tensions of the pure liquid(s) in air. To understanding multiphase wettability, FIG. 2 illustrates three scenarios: solid-water-air, solid-oil-air (both single phase), and solid-oil-water (multiphase). While the individual single phase situations are very similar to the Young's case illustrated in FIG. 1, the multiphase situation illustrates how different surface and interface energies need to be considered while designing for multiphase wettability.

### Tailoring Wettability in Multiphase Systems

The present disclosure provides methods in tailoring wettability in multiphase systems. For the solid-oil-water system illustrated in FIG. 2, the wetting of a surface by oil (while in an aqueous phase) is more related to the individual surface energies of solid-oil, and solid-water systems, and also the interface energy of the oil-water system. Thus, a surface can be oleophilic in air, but oleophobic in water, and vice versa, depending upon the relative values of γso, γsw and γow. This has implications with respect to design of surfaces for multiphase environments, as noted below:

Bare carbon steel is generally hydrophilic and oleophilic, but there may be a tendency to preferentially wet bare carbon steel with water in a water-oil environment. This can be explained by considering that for the case of carbon steel, γsw<γso. In such a case, bare carbon steel has a tendency to be oleophobic in a water-oil environment. In other words, an oil droplet on a carbon steel surface, which will wet in air, can actually form a high-contact angle oil droplet while in water.

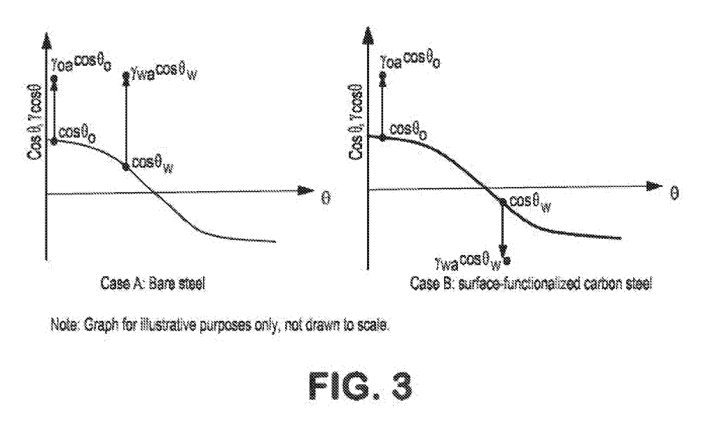

It is discovered that if the carbon steel is adequately functionalized, either through the application of a low-surface energy coating (e.g., fluorinated coating) or by chemical modification of the surface through other means (e.g., ion implantation, surface alloying, etc.), there exists the potential to adequately modify the γsw and γso values such that the surface can be preferentially wetted by oil. This can also be illustrated while considering the Young's contact angles for the surface with oil (θₒ) and water (θ_{w}) respectively, as depicted in the equation within FIG. 2. For preferential oil wetting (in water), a low value of γow is desired, or in other words, cos θow needs to be as close to 1 as possible. Realizing that the values of γoa and γwa (i.e. the surface tensions of oil and water in air respectively) are fixed (once the choice of the “oil” phase is made), the means to manipulating the contact angle of oil in water is through the manipulation of the Young's contact angle of oil and water through surface chemistry. This is schematically illustrated in FIG. 3 for the case of water (γwa=72 mN/m) and heptane (γoa=21 mN/m). The interface energy for heptane in water (γow) has been measured (through separate experiments) to be about 50 mN/m. As can be seen, surface functionalization to create a hydrophobic surface in air (θ_{w}>90°) which is still oleophilic in air (θo<90°) can have a very significant impact on oil wettability in water. An oleophilic surface in water (θow significantly less than 90°) can be realized through such a design approach. It may be noted that an oleophilic surface in water can still be created while having a hydrophobic and oleophobic surface (in air), but this is not required (note: it is also very difficult to create an ultra-low energy oleophobic surface in air through pure surface chemistry modification). More importantly, it is critical to note that creation of a hydrophobic surface through Cassie-Baxter design (i.e. through surface texturing only) will not aid in the creation of an oleophilic surface in water, as the C-B design for hydrophobicity does not alter the Young's contact angle (or in other words, the surface energies γsw and γso). Rather, the use of texturing (or C-B surface design) can be utilized to further accentuate the effect of surface chemistry modification to make a surface even more oleophilic (if required). This is readily perceived by considering the multiphase oil-water system as a single phase system (similar to solid-oil-air) where the “air” phase is replaced by “water”. In such a case, θow essentially is the Young's contact angle of an oil droplet in water. For the case of a roughened or textured surface, the appropriate Wenzel and Cassie-Baxter formulations can be readily derived (from FIG. 1) for the solid-oil-water case. It is apparent that a Wenzel wetting of a surface by oil in water would then enhance oleophobicity or oleophilicity, while C-B wetting (where the pockets are water-filled) can lead to oleophobicity or oleophilicity depending upon the surface roughness of the texturing. However, the dominant effect in determining oleophobicity or oleophilicity still comes from the surface chemistry component, as described here.

Accordingly, a surface can be chosen/designed to be oleophobic in water (e.g., carbon steel), depending upon the values of the surface energies offered.

Once the surface tensions of the two liquids (in air) and the interface tension is known/measured, a surface chemistry can then be selected or designed for more or less wettability of a liquid while immersed in the other liquid.

Thus, in one aspect, the present disclosure provides a method of modifying or tuning the wettability of a surface in a multiphase condition including: providing a surface and a multiphase fluid, e.g., a solution or emulsion; modifying the surface chemically, and/or functionalizing the surface physically, wherein the method effectuates the modification or tuning of the multiphase wettability of the surface.

In one embodiment, the multiphase solution in the method of modifying or tuning the wettability of a surface in a multiphase condition is an immiscible or partially miscible mixture of at least two different liquids with distinct surface tensions. In another embodiment, the method of modifying or tuning the wettability of a surface in a multiphase condition provides a surface with at least one liquid contact angle in air to be 90 degrees or higher, and another liquid contact angle in air to be 20 degrees or lower. In yet another embodiment, the method of modifying or tuning the wettability of a surface in a multiphase condition provides a surface with one liquid contact angle in another liquid to be 20 degrees or lower. In yet another embodiment, the method of modifying or tuning the wettability of a surface in multiphase conditions provides a surface with one liquid contact angle in another liquid to be 100 degrees or higher. In each of the latter two embodiments, the liquid of interest (i.e. where the contact angle or wettability is specified) can have higher or lower surface tension than the other liquid phase.

In certain embodiments, the chemical modification in the method of modifying or tuning the wettability of a surface in a multiphase condition comprises at least one of application of a coating, ion implantation, surface alloying or other associated techniques or a combination thereof. In one embodiment, the chemical modification is application of a coating. In certain embodiments, the coating is at least one of a fluorinated polymer coating or a silicone-based polymer coating.

In certain embodiments, the physical functionalization in the method of modifying or tuning the wettability of a surface in a multiphase condition comprises at least one of micro-patterning, etching, or casting to create a rough or patterned texture. In one embodiment, the physical functionalization is micro-patterning.

In certain embodiments, the description provides a method of modifying or tuning the wettability of a surface in a multiphase condition including: providing a surface and a multiphase fluid, e.g., a liquid, solution or emulsion; modifying the surface chemically, and/or functionalizing the surface physically, wherein the surface is hydrophobic and oleophilic in air, and wherein the method effectuates the modification or tuning of the multiphase wettability of the surface.

In another aspect, the description provides a micro-patterned fluorinated carbon steel surface that is produced according to the methods described herein.

In yet another aspect, the description provides a micro-patterned silicone-treated carbon steel surface that is produced according to the methods described herein.

### Decelerating Corrosion of a Metallic Materials Surface

The methods described herein are also directed to modifying a metallic material surface allowing the less corrosive liquid in the multiphase system to preferentially wet the surface, and consequently, decelerating corrosion of the metallic material surface under multiphase conditions. The surface of the metallic material can be chemically treated, e.g., coating on the internal surface of a pipe, and physically functionalized, e.g., micro-patterning.

For example, corrosion of plain carbon steel is a known issue in the oil industry. An essential ingredient to corrosion is the requirement of contact between the electrolyte (water) and anode (steel) to enable the corrosion reaction to occur through dissolution of Fe into solution. If a barrier can be created between the steel surface and the electrolyte, this corrosion reaction can be suppressed or slowed down. Coatings have been considered as a possible means to provide this protective barrier in the past. Another means to provide the barrier, in a partially in-situ manner, is through the creation of a protective oil film that preferentially wets the steel surface instead of the water. Such an oil film can be created and replenished in a crude containing environment, and form an effective barrier to corrosion.

As outlined above, bare carbon steel can generally be preferentially water wetting in the presence of oil (note the high contact angle of heptane in water on bare carbon steel). However, if the surface energy of the bare steel can be changed through effective manipulation of the chemistry, the steel can be made to be preferentially oil wetting. One way to enable this is through application of a lower-energy coating, such as a fluorinated polymer or a silicone-based polymer, which can provide surface energies in the range of 15-25 mN/m. While this approach appears to be akin to the application of a coating, the underlying physics, and the selection of a coating with the right surface energy are unique to this approach to prevent corrosion. It should also be noted that the low surface energy can be imparted to the steel through other techniques such as ion implantation, surface alloying, selective surface oxidation etc., which differ from the generally practiced approach of application of a polymer or epoxy coating.

With this approach, a low surface energy treatment to steel will essentially change the balance of cos θo and cos θw (see FIG. 3) which in turn will affect the wettability of oil in water, as described above. The selection of the appropriate surface chemistry will enable near-complete to full oil wetting of the surface, and lead to isolation of water from the surface, thus decelerating the corrosion reaction rate.

Thus, in one aspect, the description provides a method of decelerating corrosion of a metallic material surface comprising: providing a material having a surface; modifying the surface of the metallic material surface chemically, and/or functionalizing the metallic material surface physically; and exposing the metallic material surface to a multiphase solution, wherein the method effectuates a reduction in corrosion of the surface as compared to an unmodified metallic material surface.

In certain embodiments, the multiphase solution in the method of decelerating corrosion of a metallic material surface is an immiscible or partially miscible mixture of at least two different liquids with distinct or disparate surface tensions. In another embodiment, the method of decelerating corrosion of a metallic materials surface provides a surface with at least one liquid contact angle in air to be 100 degrees or higher, and another liquid contact angle in air to be 20 degrees or lower. In yet another embodiment, the method of decelerating corrosion of a metallic material surface provides a surface with one liquid contact angle in another liquid to be 20 degrees or lower. In yet another embodiment, the method of modifying or tuning the wettability of a surface in multiphase conditions provides a surface with one liquid contact angle in another liquid to be 100 degrees or higher. In each of the latter two embodiments, the liquid of interest (i.e. where the contact angle or wettability is specified) can have higher or lower surface tension than the other liquid phase. In general, the surface of interest can be modified through physical and/or chemical functionalization to achieve any desired contact of a particular liquid while in contact with another liquid (i.e. multiphase condition).

In certain embodiments, the chemical modification in the method of decelerating corrosion of a metallic material surface comprises at least one of application of a coating, ion implantation, surface alloying or other associated techniques or a combination thereof. In one embodiment, the chemical modification comprises application of a coating, and the coating comprises a fluorinated polymer coating or a silicone-based polymer coating.

In certain embodiments, the physical functionalization in the method of decelerating corrosion of a metallic material surface comprises at least one of micro-patterning, etching, or casting to create a rough or patterned texture. In one embodiment, the physical functionalization is micro-patterning.

In certain embodiments, the description provides a method of decelerating corrosion of a metallic materials surface including: modifying the surface of the metallic materials surface chemically, and/or functionalizing the metallic materials surface physically; and exposing the metallic materials surface to a multiphase solution; wherein the metallic materials surface is hydrophobic and oleophilic in air and the method effectuates a reduction in corrosion of the metallic materials surface as compared to an unmodified metallic materials surface.

In another aspect, the description provides a metallic materials surface that is produced according to the methods of decelerating corrosion of a metallic materials surface as described above.

### Drag Modification in a Pipe

In most liquid flow operations, viscous flow and friction at the boundary layer creates drag that can lead to turbulence, energy losses in flow. Typical approaches to drag reduction involve manipulation of the intrinsic flow rate of the fluid, or through design of effective surface chemistry for low friction/drag. Such an approach is used to minimize drag in long-distance transport of gas in gas transmission pipelines. In such applications, an epoxy coating may be applied to the pipe ID to reduce surface roughness and minimize drag.

The present disclosure encompasses the management of surface energy, which can enable effective management of relative wetting of liquids in multiphase conditions and systems, and consequently, enabling direct impact on drag. The present disclosure also encompasses the creation of a modified surface, which enables reduction of drag in multiphase flow by preferential wetting of a less viscous liquid on the surface.

The method of drag reduction of the present disclosure can be applied to surface of any materials that to be used as transportation or storage means, including pipes and storage containers in petrochemical industry. Surface of the transportation or storage means can be chemically treated, e.g., coating on the internal surface of a pipe, and physically functionalized, e.g., micro-patterning. The present disclosure can create a surface with the low viscous liquid preferential wetting the surface, and consequently, can reduce drag under multiphase conditions.

In one aspect, the description provides a method of drag modification in a pipe comprising: applying a coating on the internal surface of the pipe and/or functionalizing the internal surface of the pipe physically through micro-patterning; and exposing internal surface of the pipe to a multiphase condition, wherein the method effectuates a reduction of drag by preferential wetting of a less viscous liquid on the surface.

In one embodiment, the multiphase condition in the method of drag modification in a pipe is an immiscible or partially miscible mixture of at least two different liquids with distinct or disparate surface tensions. In certain embodiments, the coating comprises a fluorinated polymer coating or a silicone-based polymer coating.

In another aspect, the description provides a pipe that is produced according to the methods of drag modification in a pipe as described above.

### Enabling Separation of a Two-Phase Liquid System

Effective separation of two-phase liquids can be enabled through preferential wetting of one phase relative to another. Conversely, selection of the right surface chemistry can also enable the reverse effect—i.e., stopping of separation operations by preferential wetting of a liquid that can cover up pores or channels for liquid separation.

Thus, in another aspect, the description provides a method of enabling separation of a two-phase liquid system comprising: providing a material having a surface; selecting a surface chemistry for enabling separation of a two-phase liquid system; modifying the surface chemically through applying a coating and/or functionalizing the surface physically through micro-patterning; and applying the two-phase liquid on the surface, wherein one of the liquids preferentially wets the surface.

The method of enabling separation of a two-phase liquid system of the present disclosure can be applied to surface of any materials that to be used as separation means for a two-phase liquid system. Surface of the separation means can be chemically treated, e.g., coating, and/or physically functionalized, e.g., micro-patterning. The present disclosure can create a surface that one of the liquid in the multiphase system preferentially wets the surface, and consequently, enable separation in a two-phase liquid system.

In one embodiment, the two-phase liquid system in the method of enabling separation of a two-phase liquid system is an immiscible or partially miscible mixture of two different liquids with distinct surface tensions.

### EXAMPLES

The embodiments described above in addition to other embodiments can be further understood with reference to the following examples. The tests used and reported on in the following Examples:

### Example 1

Contact angles in air were measured by carefully placing a measured quantity of liquid (typically ≤5 μl) on the surface of interest (e.g., bare steel or functionalized steel) using a standard contact angle measuring instrument (VCA 2500 XE). A digital image of the droplet is obtained after which the contact angle is calculated using standard instrument software. For contact angles measured in water, the surface of interest was first immersed upside down in a large container of water. A measured quantity of oil (heptane or toluene) was then introduced in close proximity to the surface using a syringe with a curved injection nozzle. A digital image of the droplet was again captured to measure the contact angle of the oil phase in water. Calculated values of contact angle are provided based upon the equations provided at the bottom of Table 1. The values of surface tension for water, heptane and toluene in air are taken from known literature values. The values of contact angles noted below in Table 1 represent the average over 3 separate measurements. Typical standard deviation in contact angle measurements was less than 3 degrees.

Micro-patterning on surfaces evaluated in this study was created through a multi-step molding/sintering process. A master mold with the desired texture/pattern was first created in Si. Carbon steel powder (of chosen composition) was then pressed into the mold and sintered to create a patterned array of required dimensions. Coating of the micro-patterned steel surfaces was achieved through a low-temperature vapor-phase coating process. Both the patterning and coating were performed at third party vendors.

Table 1 summarizes the results of experiments conducted to illustrate design of surfaces for oleophobicity/oleophilicity while in water.

TABLE 1

| | Water | Heptane | Measured | Calculated |
|---|---|---|---|---|
| | CA (θ_{w}) | CA (θₒ) | Heptane CA | Heptane CA |
| | in air | in air | (θ_{ow}) in water | (θ_{ow}) in water |
| Surface | (deg) | (deg) | (deg) | (deg) |
| Bare carbon steel | 68 | <5 | 93 | 97 |
| Fluorinated carbon steel | 119 | <10 | 22 | 0 |
| Silicone-treated | 91 | <10 | 73 | 66 |
| Micro-patterned carbon | 109 | <10 | 130 | 145^{a}/108^{b} |
| steel | | | | |
| Micro-patterned | 135 | <10 | <5 | 127^{a}/0^{b} |
| fluorinated carbon steel | | | | |
| Micro-patterned silicone- | 119 | <10 | 125 | 136^{a}/0^{b} |
| treated carbon steel | | | | |
| | Water | Toluene | Measured | Calculated |
| | CA (θ_{w}) | CA (θₒ) | Toluene CA | Toluene CA |
| | in air | in air | (θ_{ow}) in water | (θ_{ow}) in water |
| Surface | (deg) | (deg) | (deg) | (deg) |
| Bare carbon steel | 68 | <10 | 80 | 89 |
| Fluorinated carbon steel | 119 | 27 | 37 | 0 |
| Silicone-treated | 91 | <10 | 50 | 38 |
| Micro-patterned carbon | 109 | <10 | 125 | 143^{a}/86^{b} |
| steel | | | | |
| Micro-patterned | 135 | <10 | <5 | 127^{a}/0^{b} |
| fluorinated carbon steel | | | | |
| Micro-patterned silicone- | 119 | <10 | 110 | 130^{a}/0^{b} |
| treated carbon steel | | | | |

$cos {θ}_{ow} = \frac{{γ}_{oa} cos {θ}_{o} - {γ}_{wa} cos {θ}_{w}}{{γ}_{ow}}$ ^{a}CB calculation
^{b}Wenzel calculation
For unpatterned surfaced: calculated CA: cosθ_{CB} = fₛ(1 + cosθ_{ow-calc}) − 1
For patterned surfaces: calculated CA: cosθ_{w} = r.cosθ_{ow-calc}

### PCT/EP Clauses:

1. A method of modifying or tuning the wettability of a surface in multiphase conditions, the method including the steps of providing a surface and a multiphase solution; modifying the surface chemically, and/or functionalizing the surface physically, wherein the method effectuates the modification or tuning of the multiphase wettability of the surface.

2. The method of clause 1, in which the multiphase solution is an immiscible or partially miscible mixture of at least two different liquids with distinct surface tensions.

3. The method of clause 1 or 2, in which the chemical modification comprises at least one of application of a coating, ion implantation, surface alloying or other associated techniques or a combination thereof.

4. The method of clause 3, in which the coating is a fluorinated polymer coating.

5. The method of clause 3, in which the coating is a silicone-based polymer coating.

6. The method of any of clauses 1-5, in which the physical functionalization comprises at least one of micro-patterning, etching, or casting to create a rough or patterned texture.

7. The method of any of clauses 1-6, in which the physical functionalization is micro-patterning.

8. The method of any of clauses 1-7, in which the surface is hydrophobic and oleophilic in air.

9. The method of clause 2, in which the surface has one liquid contact angle in air to be 90 degrees or higher, and another liquid contact angle in air to be 20 degrees or lower.

10. The method of clause 2, in which the surface has one liquid contact angle in another liquid to be 20 degrees or lower.

11. The method of clause 2, in which the surface has one liquid contact angle in in another liquid to be 100 degrees or higher

12. A method of decelerating corrosion of a metallic material surface, the method comprising the steps of modifying the surface of the metallic material surface chemically, and/or functionalizing the metallic material surface physically; and exposing the surface to a multiphase solution, wherein the method effectuates a reduction in corrosion of the metallic material surface as compared to an unmodified metallic materials surface.

13. A method of drag modification in a pipe, the method including steps of applying a coating on the internal surface of the pipe, and/or functionalizing the internal surface of the pipe physically through micro-patterning; and exposing internal surface of the pipe to a multiphase solution, wherein the method effectuates a reduction of drag by preferential wetting of a less viscous liquid on the surface.

14. The method of any of clauses 12-13, in which the multiphase solution is an immiscible or partially miscible mixture of at least two different liquids with distinct surface tensions.

15. The method of any of clauses 12-14, in which the chemical modification comprises at least one of application of a coating, ion implantation, surface alloying or a combination thereof

16. The method of clause 15, in which the coating is a fluorinated polymer coating.

17. The method of clause 15, in which the coating is a silicone-based polymer coating.

18. A method of enabling separation of a two-phase liquid system, the method including steps of selecting a surface chemistry for enabling separation of a two-phase liquid system; manipulating the surface chemically through applying a coating and/or functionalizing the surface physically through micro-patterning; and applying the two-phase liquid on the surface, wherein one of the liquids preferentially wets the surface.

19. The method of any of clauses 12-18, wherein the physical functionalization comprises at least one of micro-patterning, etching, or casting to create a rough or patterned texture.

20. The method of any of clauses 12-19, wherein the physical functionalization is a micro-patterning.

21. The method of any of clauses 12-20, in which the metallic material surface is hydrophobic and oleophilic in air.

22. The method of any of clauses 12-21, wherein the metallic materials surface has one liquid contact angle in air to be 90 degree or higher, and another liquid contact angle in air to be 20 degree or lower.

23. The method of clause 18, wherein the multiphase solution is an immiscible or partially miscible mixture of at least two different liquids with distinct surface tensions.

24. A metallic material surface produced according to the method of any of clauses 1-23.

25. A metallic article comprising a surface modified according to the methods of any of clauses 1-23.

While preferred embodiments of the invention have been shown and described herein, it will be understood that such embodiments are provided by way of example only and are not meant to be limiting examples. Numerous variations, changes and substitutions will occur to those skilled in the art without departing from the spirit of the invention. Accordingly, it is intended that the appended claims cover all such variations as fall within the spirit and scope of the invention. All such alternative embodiments may be covered by the scope of the invention to the extent where the stability of the resulting composition is not substantially affected.

Various modifications or changes in light thereof will be suggested to persons skilled in the art and are included within the spirit and purview of this application and are considered within the scope of the appended claims. For example, the relative quantities of the ingredients may be varied to optimize the desired effects, additional ingredients may be added, and/or similar ingredients may be substituted for one or more of the ingredients described. Additional advantageous features and functionalities associated with the systems, methods, and processes of the present invention will be apparent from the appended claims. Moreover, those skilled in the art will recognize, or be able to ascertain using no more than routine experimentation, many equivalents to the specific embodiments of the invention described herein. Such equivalents are intended to be encompassed by the following claims.

1. A method of modifying or tuning the wettability of a surface in multiphase conditions comprising:
a. providing a surface and a multiphase solution; and
b. modifying the surface chemically, and/or functionalizing the surface physically, wherein the method effectuates the modification or tuning of the multiphase wettability of the surface.

2. The method of claim 1, wherein the multiphase solution is an immiscible or partially miscible mixture of at least two different liquids with distinct surface tensions.

3. The method of claim 1, wherein the chemical modification comprises at least one of application of a coating, ion implantation, surface alloying or other associated techniques or a combination thereof

4. The method of claim 3, wherein the coating is a fluorinated polymer coating.

5. The method of claim 3, wherein the coating is a silicone-based polymer coating.

6. The method of claim 1, wherein the physical functionalization comprises at least one of micro-patterning, etching, or casting to create a rough or patterned texture.

7. The method of claim 6, wherein the physical functionalization is micro-patterning.

8. The method of claim 1, wherein the surface is hydrophobic and oleophilic in air.

9. The method of claim 2, wherein the surface has one liquid contact angle in air to be about 90 degrees or higher, and another liquid contact angle in air to be about 20 degrees or lower.

10. The method of claim 2, wherein the surface has one liquid contact angle in another liquid to be about 20 degrees or lower.

11. The method of claim 2, wherein the surface has one liquid contact angle in another liquid to be about 100 degrees or higher

12. A modified surface produced according to the method of claim 1, wherein the surface is a micro-patterned fluorinated carbon steel.

13. A modified surface produced according to the method of claim 1, wherein the surface is a micro-patterned silicone-treated carbon steel.

14. A method of decelerating corrosion of a metallic material surface comprising:
a. modifying the surface of the metallic material surface chemically, and/or functionalizing the metallic material surface physically; and
b. exposing the surface to a multiphase solution, wherein the method effectuates a reduction in corrosion of the metallic material surface as compared to an unmodified metallic material surface.

15. The method of claim 14, wherein the multiphase solution is an immiscible or partially miscible mixture of at least two different liquids with distinct surface tensions.

16. The method of claim 14, wherein the chemical modification comprises at least one of application of a coating, ion implantation, surface alloying or a combination thereof.

17. The method of claim 16, wherein the coating is a fluorinated polymer coating.

18. The method of claim 16, wherein the coating is a silicone-based polymer coating.

19. The method of claim 14, wherein the physical functionalization comprises at least one of micro-patterning, etching, or casting to create a rough or patterned texture.

20. The method of claim 19, wherein the physical functionalization is a micro-patterning.

21. The method of claim 14, wherein the metallic materials surface is hydrophobic and oleophilic in air.

22. The method of claim 15, wherein the metallic material surface has one liquid contact angle in air to be about 90 degree or higher, and another liquid contact angle in air to be about 20 degree or lower.

23. The method of claim 15, wherein the surface has one liquid contact angle in another liquid to be about 20 degree or less.

24. The method of claim 15, wherein the metallic material has one liquid contact angle in another liquid to be about 100 degrees or higher

25. A metallic material surface produced according to the method of claim 14.

26. A method of drag modification in a pipe comprising:
a. applying a coating on the internal surface of the pipe, and/or functionalizing the internal surface of the pipe physically through micro-patterning; and
b. exposing internal surface of the pipe in multiphase solutions, wherein the method effectuates a reduction of drag by preferential wetting of a less viscous liquid on the surface.

27. The method of drag modification in a pipe of claim 26, wherein the multiphase solution is an immiscible or partially miscible mixture of at least two different liquids with distinct surface tensions.

28. The method of drag modification in a pipe of claim 26, wherein the coating is a fluorinated polymer coating.

29. The method of drag modification in a pipe of claim 26, wherein the coating is a silicone-based polymer coating.

30. A pipe produced according to the method of claim 26.

31. A method of enabling separation of a two-phase liquid system comprising:
a. selecting a surface chemistry for enabling separation of a two-phase liquid system;
b. manipulating the surface chemically through applying a coating and/or functionalizing the surface physically through micro-patterning; and
c. applying the two-phase liquid on the surface, wherein one of the liquids preferentially wets the surface.

32. The method of enabling separation of a two-phase liquid system of claim 31, wherein the two-phase liquid system is an immiscible or partially miscible mixture of two different liquids with distinct surface tensions.

33. A metallic article comprising a surface modified according to the methods of any one of claim 1, 14, 26 or 31.
